(19) United States
(12) Patent Application Publication
(10) Pub. No.: US 2012/0303453 A1
(43) Pub. Date: Nov. 29, 2012

(54) METHODS AND SYSTEMS FOR SECURELY TARGETING ADVERTISEMENTS ON LOGIN PAGES

(75) Inventor: Aanchal Gupta, Cupertino, CA (US)

(73) Assignee: Yahoo! Inc., Sunnyvale, CA (US)

(21) Appl. No.: 13/116,598

(22) Filed: May 26, 2011

(51) Int. Cl. G06Q 30/00

(52) U.S. Cl. 705/14.53

(57) ABSTRACT

Methods and systems are disclosed which allow secure targeting of advertisements on pages where security is a concern, such as login pages. Cookie information may be received at one or more servers over a first domain from a browser application when a user visits a login page using the browser application. The cookie information may then be transmitted to one or more servers over a second domain. At the one or more servers, targeting information may be extracted from the cookie information, and one or more advertisements may be selected based at least in part on the extracted targeting information. The advertisements may be transmitted to the browser application over the second domain, and displayed by the browser application in an inline frame.

### BACKGROUND

Conventionally, targeted advertisements have not been presented on certain types of web pages due to a lack of targeting information, security concerns and performance limitations. Login pages are one example of such web pages. Security is a big concern on login pages because user passwords may be collected and authentication cookies may be issued for login pages. Thus, any security breaches on login pages may compromise user accounts. These security concerns have made it difficult to target advertisements to users on pages such as login pages.

There is a need for techniques for improving security of online advertising, particularly for pages such as login pages.

### SUMMARY

Some embodiments of the invention provide systems and methods in which advertisements may be targeted to users who access login pages. Cookie information may be received over a first domain from a browser application when a user visits a login page using the browser application. The domain may be, for example, a .com domain (e.g., login.yahoo.com). The cookie information, which may comprise one or more browser cookies, may be received by one or more servers.

The cookie information may then be transmitted to one or more servers over a second domain. The second domain may be, for example, a .net domain (e.g., login.yahoo.net). The one or more servers that receive the cookie information may be implemented as ad servers. Once the cookie information is received by the one or more servers, targeting information may be extracted from the cookie information at the one or more servers. The extracted targeting information may comprise demographic information. The user may be targeted with one or more advertisements based at least in part on the extracted targeting information. The advertisements may be transmitted to the browser application by one or more ad servers over the second domain (e.g., .net domain).

Some embodiments of the invention provide systems and methods in which advertisements may be securely targeted to users on login pages without compromising user accounts. Cookie information may be received over a first domain from a browser application when a user visits a login page using the browser application. The cookie information may be received by one or more servers over, for example, a .com domain. The cookie information may comprise an anonymous browser cookie. The cookie information may be transmitted to one or more servers over a second domain. The cookie information may be transmitted to one or more servers over for example, a .net domain. The servers may be implemented as one or more ad servers. In some embodiments, the cookie information may be transmitted by, for example, appending the cookie information to a URL in a SRC attribute of an iframe element. The one or more servers (e.g., ad servers) that received the cookie information, may transmit one or more advertisements to the browser application over the second domain. The browser may display the one or more advertisements in an inline frame in the browser application. In accordance with exemplary embodiments, receiving the advertisements through the iframe over a different domain than the login page allows targeting of advertisements while alleviating security issues associated with targeting advertisements on login pages in a conventional manner. For example, the login page may be loaded on login.yahoo.com and the iframe may be loaded on login.yahoo.net. This would allow scheduling of, e.g., Flash based advertisements on the login.yahoo.net domain even though Flash has known security vulnerabilities.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention;

FIG. 5 is a block diagram illustrating one embodiment of the invention.

FIG. 6 is a flow diagram illustrating a method according to one embodiment of the invention; and

FIG. 7 is a flow diagram illustrating a method according to one embodiment of the invention.

### DETAILED DESCRIPTION

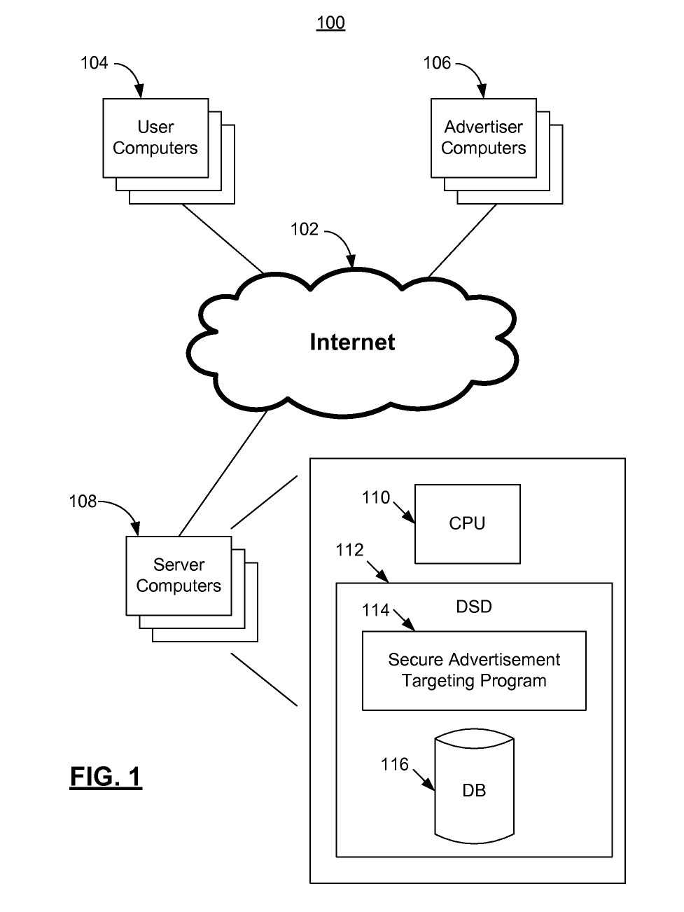

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers 104 may be or include desktop or laptop PCs, as well as, wireless, mobile, or handheld devices such as cell phones, PDAs, tablets, etc.

Each of the one or more computers 104, 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Secure Advertisement Targeting Program 114. As will be understood by one of ordinary skill in the art, advertiser computers 106 may be implemented as one or more servers similar to server computers 108.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

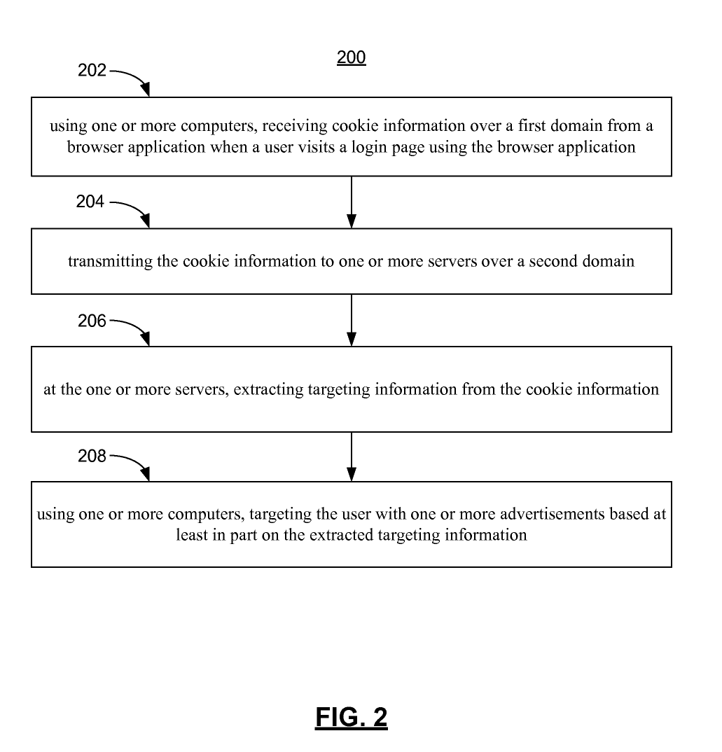

FIG. 2 is a flow diagram illustrating a method 200 according to one embodiment of the invention. At step 202, using one or more computers, cookie information may be received over a first domain from a browser application when a user visits a login page using the browser application. The domain may be, for example, a .com domain (e.g., login.yahoo.com). The cookie information, which may comprise one or more browser cookies, may be received by one or more servers. The browser application may retrieve the cookie information, which may be stored on a storage device (e.g., a HDD or a flash based storage device) in the user's computer device, prior to transmitting the cookie information to one or more servers. The computer device may include, for example, a desktop PC, a laptop, as well as mobile devices such as a smartphone, a tablet, etc. The cookie information may have been issued by one or more servers and stored on a storage device in the user's computer device when the user previously visited the login page. The cookie information may be anonymous and may be retained in the storage device even after the user logs out.

At step 204, the cookie information may be transmitted to one or more servers over a second domain. The second domain may be, for example, a .net domain (e.g., login.yahoo.net). In other words, one or more servers may receive the cookie information from a browser application over a first domain as described in step 202, and the cookie information may then be transmitted over a second domain (e.g., a .net domain) to one or more additional servers. The one or more servers that receive the cookie information in step 204 may be implemented as ad servers. As will be apparent to one or ordinary skill in the art, an ad server is a computer server, specifically a web server, that stores advertisements used in online marketing and delivers them to website visitors. The content of the web server is frequently updated so that the website or webpage on which the ads are displayed contains new advertisements (e.g., banners (static images/animations) or text) when the site or page is visited or refreshed by a user. Ad servers may be implemented as local ad servers or remote ad servers. Local ad servers are typically run by a single publisher and serve ads to that publisher's domains, allowing fine-grained creative, formatting, and content control by that publisher. Remote ad servers can serve ads across domains owned by multiple publishers. They deliver the ads from one central source so that advertisers and publishers can track the distribution of their online advertisements, and have one location for controlling the rotation and distribution of their advertisements across the web.

Once the cookie information is received by the one or more servers as described above in step 204, targeting information may be extracted from the cookie information at the one or more servers in step 206. The extracted targeting information may comprise demographic information.

In step 208, using one or more computers, the user may be targeted with one or more advertisements based at least in part on the extracted targeting information. The advertisements may be transmitted to the browser application by the one or more ad servers over the second domain (e.g., .net domain).

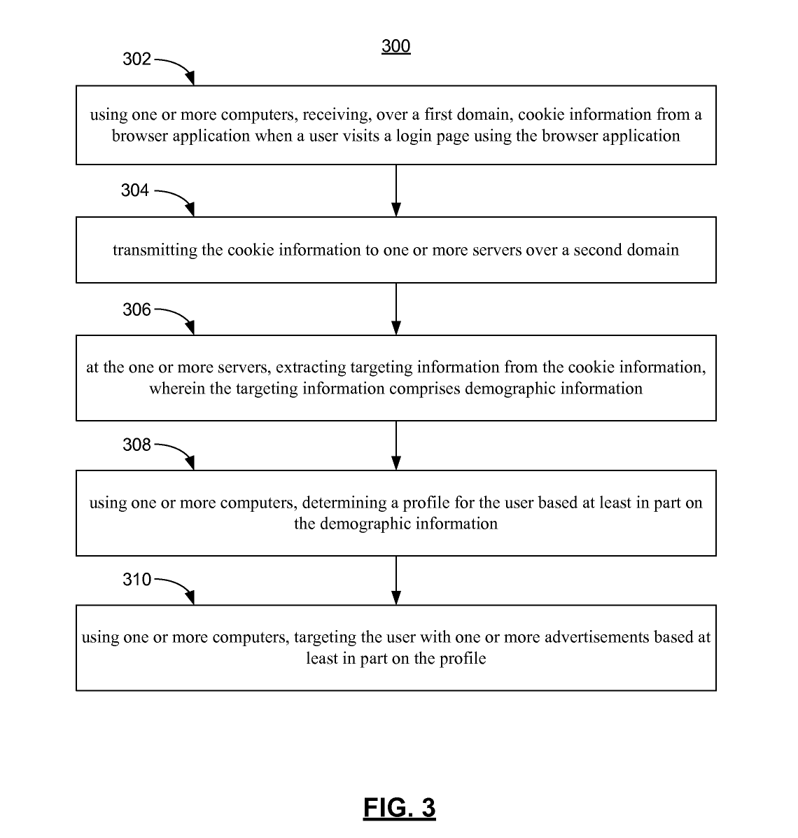

FIG. 3 is a flow diagram illustrating a method 300 according to one embodiment of the invention. At step 302, using one or more computers, cookie information may be received from a browser application over a first domain when a user visits a login page using the browser application. As discussed in the description of FIG. 2, the first domain may be a .com domain (e.g., login.yahoo.com).

At step 304, the cookie information may be transmitted to one or more servers over a second domain (e.g., login.yahoo.net). The one or more servers may be, for example, ad servers.

At step 306, targeting information may be extracted from the cookie information at the one or more servers (e.g., ad servers). The targeting information may comprise demographic information. At step 308, using one or more computers, a profile for the user may be determined based at least in part on the demographic information. At step 308, using one or more computers, the user may be targeted with one or more advertisements based at least in part on the profile. In some embodiments, the user may be targeted with advertisements based on one or more of demographic information, profile information, geographic information, social network information, device form factor (of the device the user is using to access the webpage), etc.

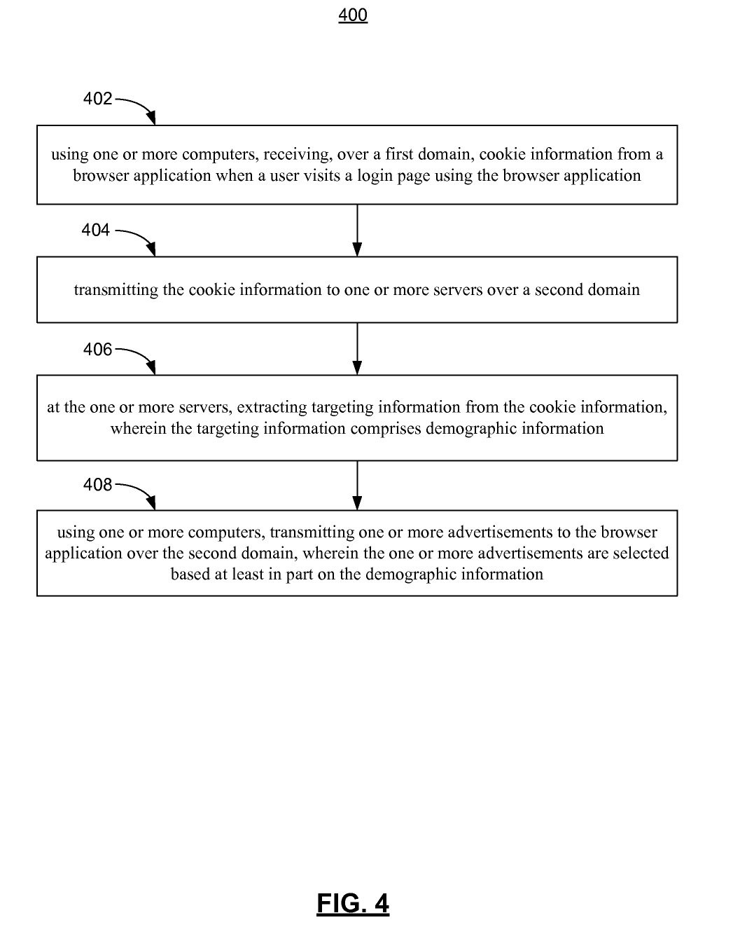

FIG. 4 is a flow diagram illustrating a method 400 according to one embodiment of the invention. At step 402, using one or more computers, cookie information may be received over a first domain from a browser application when a user visits a login page using the browser application. The cookie information may be received by one or more servers over for example, a .com domain (e.g., login.yahoo.com).

At step 404, the cookie information may be transmitted to one or more additional servers over a second domain (e.g., a .net domain). The cookie information may be transmitted over for example, a .net domain. The one or more servers that receive the cookie information transmitted in step 404 may be implemented as ad servers. In step 406, at the one or more servers (e.g., ad servers) that received the cookie information transmitted in step 404, targeting information may be extracted from the cookie information. The targeting information may comprise demographic information.

At step 408, using one or more computers, one or more advertisements may be transmitted to the browser application over the second domain (e.g., .net domain). The one or more advertisements may be selected based at least in part on the demographic information. The advertisements may be transmitted over the second domain by, for example, one or more ad servers (e.g., by the one or more servers that received the cookie information transmitted in step 404).

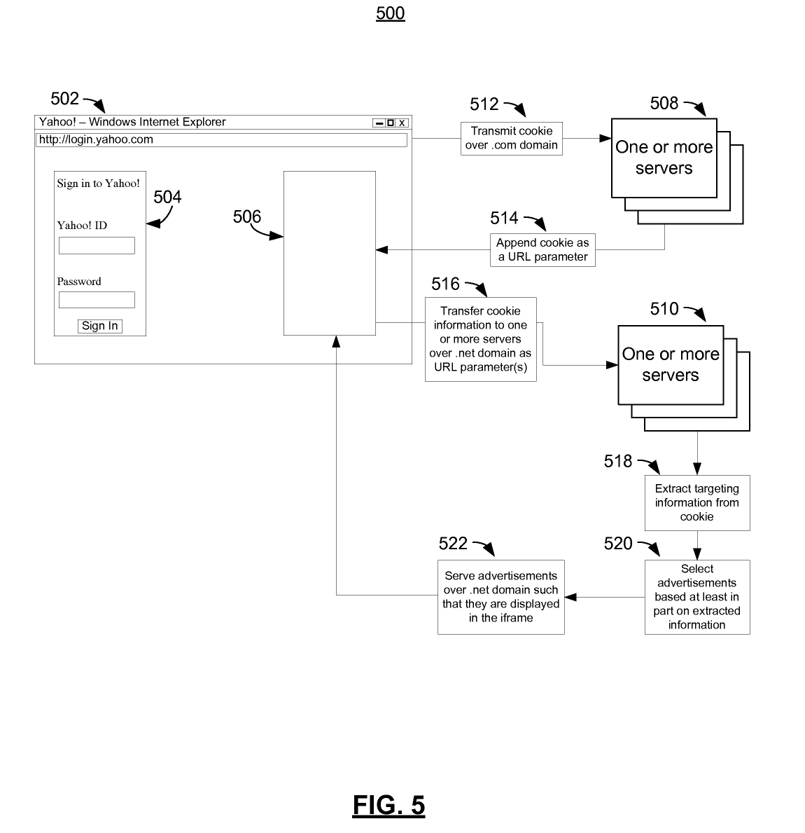

FIG. 5 is a block diagram 500 illustrating one embodiment of the invention. An exemplary login page 502 is displayed in a browser application. Webpage 502 includes login section 504 which allows users to sign in to the website. In addition, webpage 502 may display one or more frames 506. Frame 506 may be an inline frame. An inline frame is a construct which embeds a document into an HTML document so that embedded data is displayed inside a subwindow of the browser's window. However, this does not mean full inclusion; the two documents are independent, and both of them are treated as complete documents, instead of treating one as part of the other The inline frame may be defined using the iframe element in HTML.

For example, an inline frame may be defined as:

<iframe src=“http://www.yahoo.net/hello.html” width=“80%” height=“110”></iframe>

The iframe's SRC attribute provides the location of the frame content. Note that when inline frames are used, the browser application (if it supports them) sends a request to the server referred to by the URL in the SRC attribute, and after getting the requested document displays it inside the inline frame.

As depicted in block 512, when a user visits login page 502, the browser application may send cookie information to one or more servers 508 (e.g., login.yahoo.com) over a first domain. The cookie information may include, for example, an anonymous browser cookie. The browser cookie may be stored on a storage device on the user's computer device and the browser application may retrieve the cookie and transmit it to one or more servers 508. One or more servers 508 may read the cookie information and append the cookie information as a URL parameter to the iframe call to one or more servers over a second domain (e.g., login.yahoo.net), as depicted in block 514. In other words, one or more servers 508 may append the cookie information to the URL in the SRC attribute of the iframe element which refers to one or more servers on a second domain such as, login.yahoo.net. For example, the login.yahoo.com server may append the cookie information as follows:

<iframe src=“http://login.yahoo.net/?PHPSESSID=1b56f3fd797a22cb716022b05f5db34d”
width=“80%” height=“110”> </iframe>

Thus, as depicted in block 516, when the browser application interprets the iframe element, it will access the URL identified in the SRC attribute in the above example. One or more servers 510 on the domain defined in the URL may receive the cookie information appended to the URL. These servers 510 may be implemented as ad servers. Once the cookie information is received by one or more servers 510, targeting information may be extracted from the cookie information as depicted in block 518. Alternatively, or in addition to the cookie information, other information may also be appended to the URL. For example, one or more servers 508 may do a reverse lookup on the IP address received from the browser application to determine the user's geographic location. This may then be appended to the URL such that the iframe may pass this information to one or more servers 510.

As depicted in block 520, one or more servers 510 may select one or more advertisements based at least in part on the cookie information. The selected advertisements may be transmitted to the browser application over the second domain (e.g., .net domain) for display in the iframe as depicted in block 522. In accordance with exemplary embodiments, receiving the advertisements through the iframe over a different domain than the login page allows targeting of advertisements while alleviating security issues associated with receiving advertisements on login pages in a conventional manner. For example, the login page may be loaded on login.yahoo.com and the iframe may be loaded on login.yahoo.net. This would allow scheduling of e.g., Flash based advertisements on the login.yahoo.net domain even though Flash has known security vulnerabilities.

In accordance with some embodiments, users may be targeted with advertisements based on one or more of demographic information, geographic location information, device form factor information, social networking information, etc. For example, demographic information may be extracted from cookie information and geographic location may be determined using a reverse lookup on the IP address as described above. In addition, the form factor of the device the user is using to access the webpage may also be a factor in selecting advertisements to target to the user. The HTTP_USER_AGENT string may be used to determine the form factor of the device being used by the user. For example, the HTTP_USER_AGENT may indicate that the user's device is a tablet or a smartphone. Advertisements may then be selected appropriately such that they can be properly displayed on that device. In addition, different layouts of the advertisements may be displayed based on the orientation (e.g., portrait or landscape) of the device.

In some embodiments, users may also be targeted based on their social networking graph. Since users are not signed in when they first access the login page, it is difficult to acquire information regarding the user's social network. However, in instances where users are required to re-authenticate or verify their login, users may be targeted based on their social networking graph. For example, these users' identities are known through their globally unique identifiers (GUID) and their friends' GUIDs may be determined based on this information. A GUID is a unique 128-bit number that is generated and assigned to a user. These users may then be targeted not just based on their profile but also based on their friends' profiles. It should be noted that the factors discussed above (e.g., demographic information, geographic location information, device form factor information, social networking information, etc.) that may be used to target users may be used independently or in combination with each other.

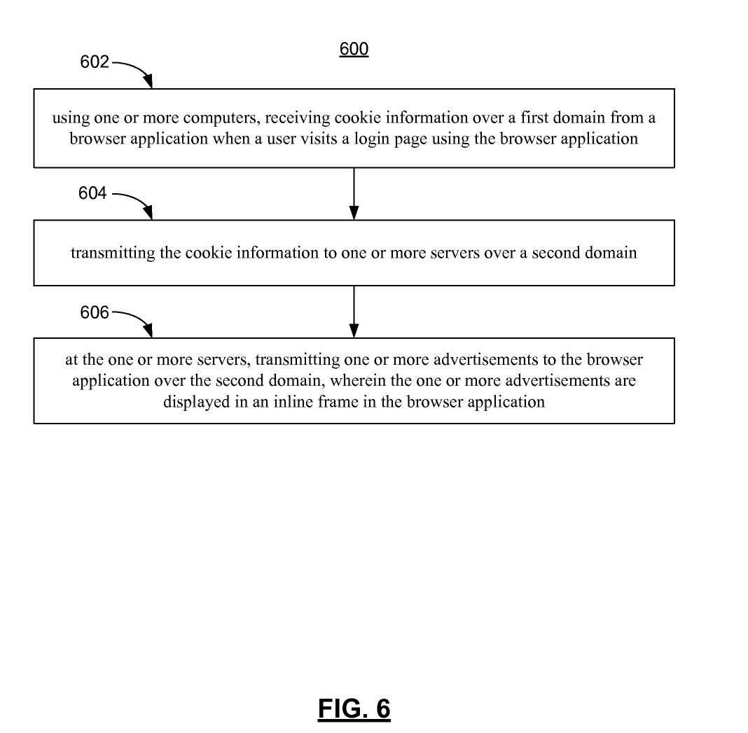

FIG. 6 is a flow diagram illustrating a method 600 according to one embodiment of the invention. At step 602, using one or more computers, cookie information may be received over a first domain from a browser application when a user visits a login page using the browser application. The cookie information may be received by one or more servers over, for example, a .com domain. The cookie information may comprise an anonymous browser cookie. At step 604, the cookie information may be transmitted to one or more servers over a second domain. The cookie information may be transmitted to one or more servers over for example, a .net domain. The servers may be implemented as one or more ad servers. In some embodiments, the cookie information may be transmitted by, for example, appending the cookie information to a URL in a SRC attribute of an iframe element. At step 606, the one or more servers (e.g., ad servers) that received the cookie information in step 604, may transmit one or more advertisements to the browser application over the second domain. The browser may display the one or more advertisements in an inline frame in the browser application. The advertisements may include text, audio, video, and/or graphical data. The one or more servers may select the advertisements based at least in part on the received cookie information. In some embodiments, the one or more servers may extract targeting information from the cookie information and select one or more advertisements based at least in part on the targeting information.

In some embodiments, login pages may be served over, for example, the HTTPS protocol due to security requirements. Thus, advertisements may have to be received over SSL. However, this may negatively impact the loading of the webpage since the advertisement content may incur a SSL handshake delay. In some embodiments, to avoid this delay, a timeout (for e.g., 4 seconds) may be added to the page such that if the content is not received within the timeout period, the iframe may be hidden and only the static content (e.g., login section 504 in FIG. 5 with some additional static text) would be displayed.

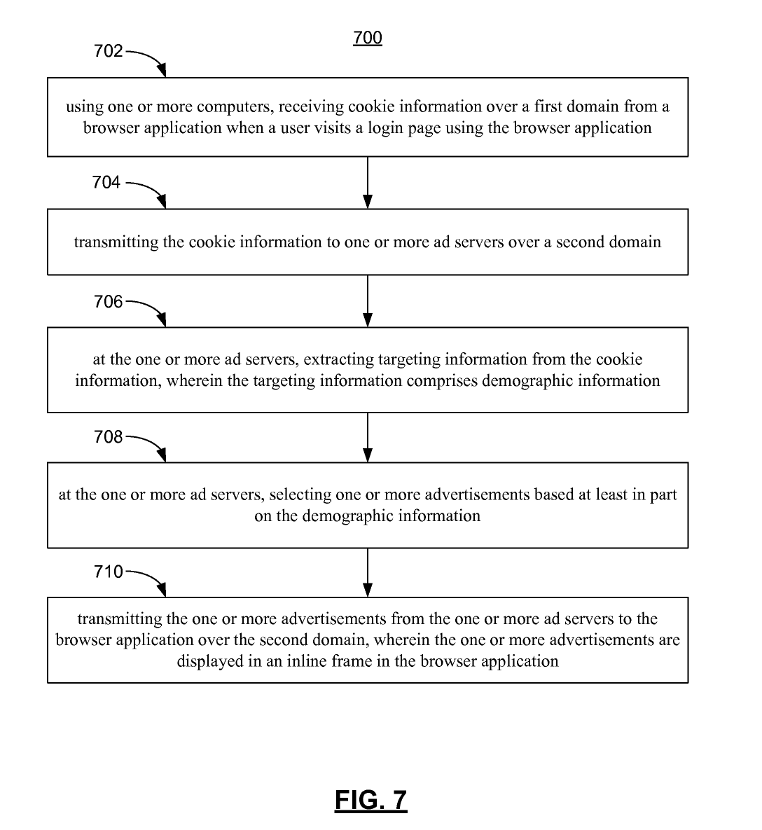

FIG. 7 is a flow diagram illustrating a method 700 according to one embodiment of the invention. At step 702, using one or more computers, cookie information may be received over a first domain (e.g., a .com domain) from a browser application when a user visits a login page using the browser application. The cookie information, which may comprise an anonymous browser cookie, may be received by one or more servers. At step 704, the cookie information may be transmitted to one or more ad servers over a second domain (e.g., a .net domain). In some embodiments, the cookie information may be transmitted by, for example, appending the cookie information to a URL in a SRC attribute of an iframe element. At step 706, at the one or more ad servers, targeting information may be extracted from the cookie information. The targeting information may comprise demographic information. At step 708, at the one or more ad servers, one or more advertisements may be selected based at least in part on the demographic information. At step 710, the one or more advertisements may be transmitted from the one or more ad servers to the browser application over the second domain (e.g., .net domain). The one or more advertisements may be displayed in an inline frame in the browser application. In accordance with some embodiments, this would allow secure targeting and displaying of advertisements on login pages without compromising user accounts.

While the invention is described with reference to the above drawings, the drawings are intended to be illustrative, and the invention contemplates other embodiments within the spirit of the invention.

1. A method comprising:
using one or more computers, receiving cookie information over a first domain from a browser application when a user visits a login page using the browser application;
transmitting the cookie information to one or more servers over a second domain; and
at the one or more servers, transmitting one or more advertisements to the browser application over the second domain, wherein the one or more advertisements are displayed in an inline frame in the browser application.

2. The method of claim 1, further comprising:
at the one or more servers, extracting targeting information from the cookie information.

3. The method of claim 1, wherein the first domain is a .com domain.

4. The method of claim 1, wherein the second domain is a .net domain.

5. The method of claim 1, wherein at least one of the one or more servers is an ad server.

6. The method of claim 1, wherein the cookie information comprises of a browser cookie.

7. The method of claim 6, wherein the browser cookie is a non-login cookie.

8. The method of claim 2, wherein the one or more advertisements are selected based at least in part on the extracted targeting information.

9. The method of claim 8, wherein the extracted targeting information comprises demographic information.

10. A system comprising:
a first server computer coupled to a network;
a second server computer coupled to the network; and
one or more databases coupled to the first and second server computers;
wherein the first server computer is for:
receiving cookie information over a first domain from a browser application when a user visits a login page using the browser application; and
transmitting the cookie information to the second server computer over a second domain;
wherein the second server computer is for:
selecting and transmitting one or more advertisements to the browser application over the second domain, wherein the one or more advertisements are selected based at least in part on the cookie information and the one or more advertisements are displayed in an inline frame in the browser application.

11. The system of claim 10, wherein the second server computer is further configured to:
extract targeting information from the cookie information.

12. The system of claim 10, wherein the first domain is a .com domain.

13. The system of claim 10, wherein the second domain is a .net domain.

14. The system of claim 10, wherein the login page is served over a secure protocol.

15. The system of claim 10, wherein the cookie information comprises of a browser cookie.

16. The system of claim 15, wherein the browser cookie is a non-login cookie.

17. The system of claim 11, wherein the one or more advertisements are selected based at least in part on the extracted targeting information.

18. The system of claim 17, wherein the extracted targeting information comprises demographic information.

19. The system of claim 14, wherein the secure protocol is HTTPS.

20. A computer readable medium or media containing instructions for executing a method comprising:
using one or more computers, receiving cookie information over a first domain from a browser application when a user visits a login page using the browser application;
transmitting the cookie information to one or more ad servers over a second domain;
at the one or more ad servers, extracting targeting information from the cookie information, wherein the targeting information comprises demographic information;
at the one or more ad servers, selecting one or more advertisements based at least in part on the demographic information; and
transmitting the one or more advertisements from the one or more ad servers to the browser application over the second domain, wherein the one or more advertisements are displayed in an inline frame in the browser application.
